(19) United States
(12) Patent Application Publication
(10) Pub. No.: US 2006/0007509 A1
(43) Pub. Date: Jan. 12, 2006

(54) Image forming apparatus

(76) Inventors: Shinji Imagawa, Nara (JP); Hiroshi Kawano, Nara (JP)

Correspondence Address: EDWARDS & ANGELL, LLP, P.O. BOX 55874, BOSTON, MA, 02205, US

(21) Appl. No.: 11/176,502

(22) Filed: Jul. 6, 2005

(30) Foreign Application Priority Data
Jul. 6, 2004 (JP) 2004-199647

(51) Int. Cl. H04N 1/46

(52) U.S. Cl. 358/504

(57) ABSTRACT

One embodiment is an image forming apparatus that digitally performs image processing and correction processing of image information, and calculates toner consumption by performing a pixel count of the input multi-level image includes a counting portion that counts, pixel by pixel, the input signal levels of an input multi-level image; a weighting coefficient table that stores weighting coefficients corresponding to the input signal levels; a weighting calculation portion that obtains from the weighting coefficient table weighting coefficients corresponding to the input signal levels and performs weighting of each pixel when counting the input signal levels with the counting portion; and a rewriting portion that rewrites the weighting coefficients stored in a weighting coefficient table.

### CROSS REFERENCE TO RELATED APPLICATION(S)

This application claims priority under 35 U.S.C. § 119(a) to Japanese Patent Application No. 2004-199647, filed on Jul. 6, 2004, the entire contents of which are hereby incorporated by reference.

### BACKGROUND OF THE INVENTION

1. Field of Invention

The present invention relates to image forming apparatuses such as copy machines, laser beam printers, facsimile apparatuses, and the like using an electrophotographic method wherein image processing and correction processing of image information is digitally performed.

2. Related Art

Generally, with image processing in electrophotographic apparatuses such as digital copy machines, a digital image signal input by an image input apparatus such as a scanner is output as an output image signal after such digital signal processing as input signal processing, region separation processing, color correction processing, black generation processing, zoom variable power processing, and the like, then performing filter processing with a spatial filter, and also performing halftone correction processing.

FIG. 5 shows a control block diagram of image processing for a conventional digital copy machine. This conventional digital copy machine includes an input signal processing portion 110, a region separation processing portion 120, a color correction/black generation processing portion 130, a zoom variable power processing portion 140, a spatial filter processing portion 150, a halftone correction processing portion 160, a pixel counting portion 170, and a toner consumption calculating portion 180.

The image processing in this sort of digital copy machine is explained with reference to FIG. 6.

First, the digitally input image signal of the manuscript read into a scanner or the like is input into the input signal processing portion 110, and preprocessing for the subsequent image processing, input gamma correction by image adjustment, and conversion are performed (Step S101, S102).

Next, this image signal is input into the region separation processing portion 120, regions such as text regions and halftone dot photograph regions are judged, and an identification signal showing the judgment of those regions (a region separation identification signal) is added (Step S103). This region separation identification signal is used when, in the spatial filter processing portion 150 and the halftone correction processing portion 160 that are used for subsequent processing, performing processing differing for each region, for example, performing smoothing filter processing for halftone regions or performing edge emphasis filter processing for text regions, or when changing the halftone gamma properties to properties with clearer grayscale difference properties.

The color correction/black generation processing performed in the following color correction/black generation processing portion 130 (Step S104) is a necessary process when the apparatus is a color apparatus, and this processing converts the RGB image signal sent from the region separation processing portion 120 to a CMYK (yellow, magenta, cyan, black) image signal, which is the final output method.

After the variable power processing in the zoom variable power processing portion 140 (Step S105), the image signal converted to CMYK is input to the spatial filter processing portion 150. In the spatial filter processing portion 150, a spatial filter is chosen from the spatial filter table in accordance with the region separation identification signal and the image mode setting state, and spatial filter processing is performed on the image signal converted to CMYK (Step S106). The spatial filter table is a table group of filter coefficients referred to when performing the spatial filter processing, wherein it is possible to select a desired table according to the circumstances.

Correction of the halftone gamma properties is performed (Step S107) in the next halftone correction processing portion 160, in order to correct the output properties at an engine portion.

Further, the image signal after halftone correction processing is input to the pixel counting portion 170, and is summed by the counter while weighting each CMYK signal in pixel units (Step S108). Then, the output image signal flows to the LSU or LED engine output (Step S110). In the toner consumption calculating portion 180, the toner consumption for each color is calculated from the pixel count sum value summed in the pixel counting portion 170 (Step S109). The calculated toner consumption is used for accumulation of toner consumption data and determining when the toner is near the end of its life.

The engine of the type of digital copy machine described above is controlled such that a constant toner density and image output is output from the beginning until the end of toner life, by controlling the setting of process conditions such as developing bias values and the amount of exposure and toner density correction, in order to suppress aging of photosensitive bodies, developer, and the like.

FIG. 7 is a flow chart showing a simplified view of the toner density control processing, which is a control performed on the engine side. With this toner density control processing, the control value of the toner density sensor is determined from the values of the life counter and environment sensor (Step S111, S112), and ON/OFF of the toner refilling is controlled according to that value. That is, when the toner density is low (when judged YES in Step S113), the toner refill is turned ON, and controlled such that toner is refilled (Step S114). Thereby, the toner density is controlled such it is always kept constant.

FIG. 8 is a flow chart showing a simplified view of the halftone gamma correction processing by the toner patch. With this halftone gamma correction processing, a toner patch is formed on a photosensitive body or a transfer belt (Step S121 to S123) with a halftone pattern (tone) according to a predetermined fixed input level, and the reflected light quantity of the toner patch is read by a reading device such as an optical sensor (Step S124). Next, the sensor output level of the read toner patch is compared to the standard target level which is the target level, and the amount of correction is calculated (Step S125). Then, according to that calculated amount of correction, the current halftone gamma correction table is revised (Step S126), and thereby, controlled such that constant halftone gamma properties are always obtained.

Next, the calculation of the toner consumption noted above will be described in detail. The processing stated below is performed with respect to each CMYK color (each input CMYK signal).

The pixel counting portion 170 performs a pixel count as described below for the input multi-level image. As shown in FIG. 5, the pixel counting portion 170 is provided with a counting means 171, a weighting calculation means 172, a weighting coefficient table 173, and a summing means 174.

The counting means 171 counts each pixel of the input multi-level image (for example, multi-grade images such as 16-grade and 256-grade images). That is, input signals such as the input level (grade) of each pixel constituting a multi-level image, for example 0 to 15 (in the case of a 16-grade image wherein the input signal takes on the levels 0 to 15) are counted.

The weighting calculation means 172 performs weighting of each pixel when counting the pixels with the counting means 171. Specifically, the weighting calculation means 172 obtains a weighting coefficient corresponding to the input signal level of each pixel from the weighting coefficient table 173, and multiplies the obtained weighting coefficients by the input signal levels. Weighting coefficients corresponding to each pixel input level when weighting is performed by the weighting calculation means 172 are stored in the weighting coefficient table 173. In this way, in the pixel counting portion 170, a pixel count is performed for each pixel by the counting means 171, the weighting calculation means 172, and the weighting coefficient table 173.

Summation of the pixel count performed for each pixel is performed by the summing means 174. That is, the summing means 174 sums the calculated value for each pixel wherein a weighting coefficient has been multiplied by the input signal level by the weighting calculation means 172, over all pixels of the input multi-level image. In this way, based on the sum value of the pixel count calculated by the pixel counting portion 170, the toner consumption calculating portion 180 calculates the toner consumption of the output image.

The weighting coefficient stored in the weighting coefficient table 173 is a fixed value set in advance. An example of the weighting coefficient table 173 when the input signal takes 16 levels from 0 to 15 is shown in the following Table 1.

Conventional Art

TABLE 1
Weighting Coefficient Table (Fixed)

| | Signal | Weighting |
|---|---|---|
| | input level | coefficient |
| Area 1 | 0 to 4 | 0 |
| Area 2 | 5 to 8 | 1 |
| Area 3 | 9 to 12 | 3 |
| Area 4 | 13 to 15 | 4 |

Table 1 is divided into four areas (area 1 to area 4) corresponding to the different input signal levels of toner consumption, and a weighting coefficient is set for each area. When counting pixels, the weighting coefficient, which is divided into the four areas, is set corresponding to the respective input signal levels that take on the levels 0 to 15.

FIG. 9 shows the relationship between signal input levels of the weighting coefficient table divided into the four areas shown in Table 1 and the corresponding weighting coefficients. As shown in FIG. 9, the total area of the rectangular portions roughly matches the area of the curve showing the toner consumption properties, and therefore it is possible to predictably calculate the toner consumption from the pixel count sum value after weighting.

Image forming apparatuses have been proposed wherein toner thin layer nonuniformities are efficiently prevented when successively printing images which have an extremely small toner consumption rate (for example, JP 2002-287499A). Particularly, image forming apparatuses have been disclosed that have a pixel counter, a recording page counter, and a toner consumption means, wherein when a number of pixels below a predetermined level have been counted during a predetermined number of recording pages, during process control, along with performing a judgment that a consumption action is executed by the toner consumption means, the toner consumption means is created at the same time as creation of the process control toner patch when executing the consumption action.

However, in conventional electrophotographic apparatuses such as digital copy machines, there were the following problems.

As stated above, when performing the pixel count and calculating the toner consumption of the output image, a weighting coefficient table was used in which was stored a fixed weighting coefficient set in advance. Incidentally, when using this sort of weighting coefficient table, as shown in FIG. 9, the weighting coefficient determined from the weighting coefficient table for a particular input signal level may differ greatly from the value on the curve that shows the toner consumption properties for that input signal level. Therefore, there is the problem that the toner consumption cannot be accurately calculated from the sum value of the pixel count after weighting.

In this case, for example, as shown in FIG. 10, a method is conceivable wherein the difference between the actual toner consumption properties and the toner properties calculated by the pixel count is decreased by using a weighting coefficient table in which the levels that can be taken from the input signal levels, that is, the weighted coefficients of the tone numbers of the input signal, are apportioned. However, when the toner consumption properties change from curve D shown by the solid line in FIG. 10 to the broken line shown by curve E due to individual differences or toner life, it is not possible to follow the change in the toner properties by simply raising the number of gradations of the weighting coefficient table, the difference between the actual toner consumption properties and the toner properties calculated by the pixel count cannot be reduced, and toner consumption cannot be accurately calculated.

### SUMMARY OF THE INVENTION

The present invention was made in light of the problems in the conventional technology mentioned above, and it is an object thereof to provide an image forming apparatus that can accurately calculate toner consumption irregardless of individual differences and toner life.

The present invention is configured in the following manner as a means for solving the problems mentioned above. That is, according to the present invention, an image forming apparatus that digitally performs image processing and correction processing of the image information and calculates toner consumption by performing a pixel count of the input multi-level image comprises: a counting portion (counting means) that counts, pixel by pixel, input signal levels of the input multi-level image; a weighting coefficient table that stores weighting coefficients corresponding to the input signal for the input signal levels of the input multi-level image; and a weighting calculation portion (weighting calculation means) that obtains from the weighting coefficient table weighting coefficients corresponding to the input signal levels and performs weighting of each pixel when the input signal levels are counted by the counting portion; wherein the weighting coefficients stored in the weighting coefficient table are adjustable.

With the image forming apparatus configured in this manner, even when actual toner consumption properties have changed due to individual differences or toner life, by changing the weighting coefficients stored in the weighting coefficient table according to this change in toner consumption properties, it is possible to optimize the calculation of toner consumption properties. As a result, it is possible to accurately calculate toner consumption regardless of individual differences and toner life.

Also, according to the present invention, an image forming apparatus that digitally performs image processing and correction processing of the image information and calculates toner consumption by performing a pixel count of the input multi-level image may comprise: a counting portion (counting means) that counts, pixel by pixel, the input signal levels of the input multi-level image; a weighting coefficient table that stores weighting coefficients corresponding to the input signal; a weighting calculation portion (weighting calculation means) that obtains from the weighting coefficient table weighting coefficients corresponding to the input signal levels and performs weighting of each pixel when the input signal levels are counted by the counting portion; and a rewriting portion (rewriting means) that rewrites the weighting coefficients stored in the weighting coefficient table.

More specifically, the present invention may also be configured such that a reading portion that reads a toner patch is further provided, the above rewriting portion forms a plurality of toner patches on a photosensitive body or transfer belt with mutually differing tones, these multiple toner patches are read by the reading portion (reading means), and based on the result of reading these toner patches the halftone gamma properties are calculated, and according to these calculated halftone gamma properties the weighting coefficients stored in the weighting coefficient table are rewritten.

With an image forming apparatus having this sort of configuration, even when actual toner consumption properties have changed due to individual differences and toner life, it is possible to rewrite the weighting coefficient of a weighting coefficient table so that it follows this change in toner consumption properties, and the calculation of toner consumption properties can be optimized. As a result, it is possible to accurately calculate toner consumption regardless of individual differences and toner life.

### BRIEF DESCRIPTION OF THE DRAWINGS

FIG. 1 is a control block diagram showing the image processing in the image forming apparatus associated with an embodiment of the present invention.

FIG. 2 is a flow chart showing the processing of the toner consumption calculation for a single pixel.

FIG. 3 is a diagram showing the rewrite aspect of the weighting coefficient table.

FIG. 4 is a flow chart showing the rewrite processing of the weighting coefficient table.

FIG. 5 is a control block diagram showing the image processing in an image forming apparatus according to the conventional technology.

FIG. 6 is a flow chart showing the image processing in an image forming apparatus according to the conventional technology.

FIG. 7 is a flow chart showing a simplified view of the toner density control processing of the conventional technology.

FIG. 8 is a flow chart showing a simplified view of the halftone gamma correction processing by toner patch of the conventional technology.

FIG. 9 is a diagram showing the relationship between the signal input level and the corresponding weighting coefficients of the weighting coefficient table according to the conventional technology.

FIG. 10 is another diagram showing the relationship between the signal input level and the corresponding weighting coefficients of the weighting coefficient table according to the conventional technology.

### DESCRIPTION OF THE PREFERRED EMBODIMENTS

Below follows a description of an embodiment of the present invention, with reference to the accompanying drawings. The embodiment described below is one specific example of the present invention, and does not limit the technical scope of the present invention.

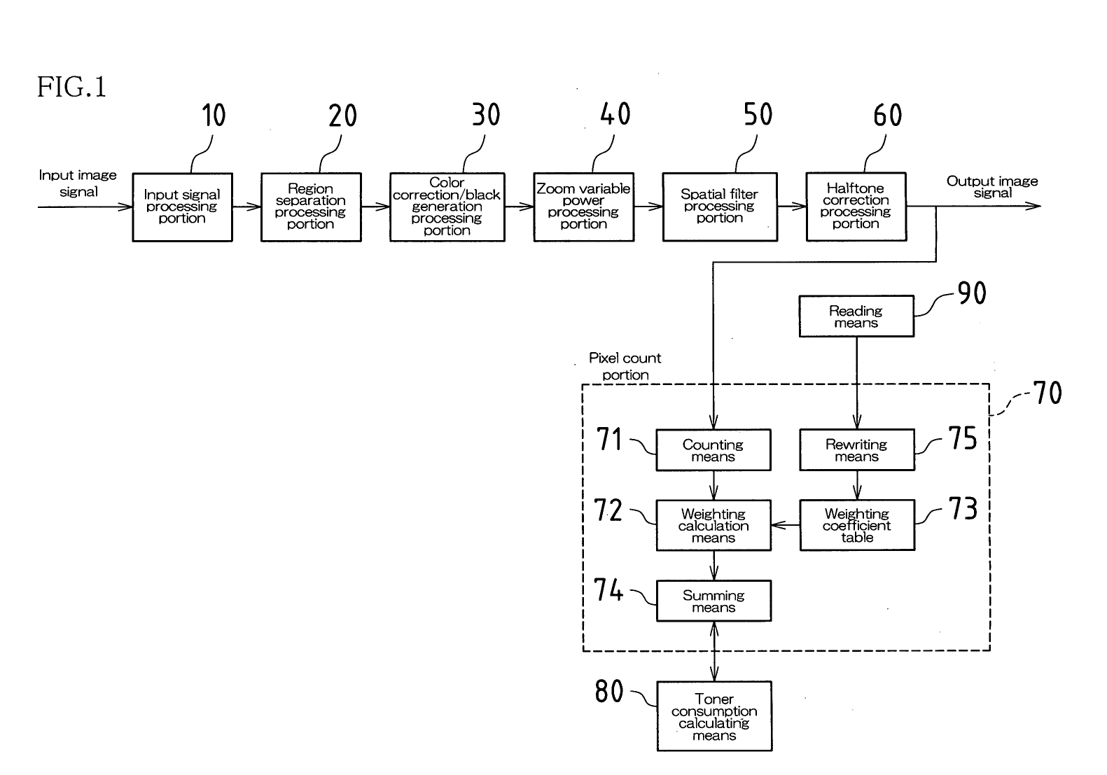

FIG. 1 is a control block diagram showing the image processing in the image forming apparatus (digital electrophotographic apparatus) associated with an embodiment of the present invention. As shown in FIG. 1, this digital electrophotographic apparatus includes an input signal processing portion 10, a region separation processing portion 20, a color correction/black generation processing portion 30, a zoom variable power processing portion 40, a spatial filter processing portion 50, a halftone correction processing portion 60, a pixel counting portion 70, and a toner consumption calculating portion (toner consumption calculating means) 80. In the digital electrophotographic apparatus, a digitally input image signal of a manuscript imported by scanner or the like, not shown in the drawings, passes through the input signal processing portion 10, the region separation processing portion 20, the color correction/black generation processing portion 30, the zoom variable power processing portion 40, the spatial filter processing portion 50, and the halftone correction processing portion 60, and is output as an output image signal. Further, a reading means 90 such as an optical sensor or the like is provided in order to read the reflected light quantity of a toner patch (details given below).

The image processing in the digital electrophotographic apparatus configured in this manner will now be explained.

In the input signal processing portion 10, preprocessing for subsequent image processing, input gamma correction processing and conversion in image adjustment are performed on the digitally input image signal of a manuscript imported by scanner or the like not shown in the drawings.

In the region separation processing portion 20, regions such as text regions and halftone dot photograph regions are judged, and an identification signal showing the judgement of those regions (a region separation identification signal) is added. This region separation identification signal is used when, in the spatial filter processing portion 50 and the halftone correction processing portion 60 that are used for subsequent processing, performing processing differing for each region, for example, performing smoothing filter processing for halftone regions or performing edge emphasis filter processing for text regions, or when changing the halftone gamma properties to properties with clearer grayscale difference properties.

In the color correction/black generation processing portion 30, the RGB image signal sent from the region separation processing portion 20 is converted to a CMYK (yellow, magenta, cyan, black) image signal, which is the final output method. In the zoom variable power processing portion 40, variable power processing is performed on the CMYK image signal converted by the color correction/black generation processing portion 30.

In the spatial filter processing portion 50, a spatial filter is selected from the spatial filter table according to the previously mentioned region separation identification signal and the image mode setting state, and spatial filter processing is performed on the image signal converted to CMYK. In the halftone correction processing portion 60, a correction of the halftone gamma properties is performed on the image signal on which spatial filter processing was performed. Then, the image signal after halftone correction processing in the halftone correction processing portion 60 is output as an output image signal.

In the pixel counting portion 70, a pixel count is performed for the image signal after halftone correction processing with the halftone correction processing portion 60, while multiplying a weighting coefficient by each CMYK signal in pixel units. In the toner consumption calculating portion 80, toner consumption is calculated for each color (CMYK) from the sum value of the pixel count.

Below, the toner consumption calculation process in the digital electrophotographic apparatus is explained in detail. The process referred to below is performed for each CMYK color (each input CMYK signal).

The pixel counting portion 70 performs a pixel count as described below for the input multi-level image. As shown in FIG. 1, the pixel counting portion 70 is provided with a counting means 71, a weighting calculation means 72, a weighting coefficient table 73, a summing means 74, and a rewriting means 75.

The counting means 71 counts each pixel of the input multi-level image (for example, 16-grade and 256-grade multi-level images). That is, it counts the input signal (grade) of each pixel constituting the multi-level image, for example, it counts an input signal level such as 0 to 15 (in the case of a 16-grade image, wherein the input signal level takes on the levels 0 to 15).

The weighting calculation means 72 performs weighting of each pixel when the pixels are counted by the counting means 71. Particularly, the weighting calculation means 72 obtains a weighting coefficient corresponding to the input signal level of each pixel from the weighting coefficient table 73, and multiplies the obtained weighting coefficient by the input signal levels. The weighting coefficients corresponding to each pixel input level when weighting is performed by the weighting calculation means 72 are stored in the weighting coefficient table 73. In this way, in the pixel counting portion 70, a pixel count of each pixel is performed by the counting means 71, the weighting calculation means 72, and the weighting coefficient table 73.

Then, summation of the pixel count performed for each pixel is performed by the summing means 74. That is, the summing means 74 sums the calculation value of each pixel having a weighting coefficient multiplied by the input signal level by the weighting calculation means 72, for every input pixel of the multi-level image. A rewriting means 75, as explained below, rewrites the weighting coefficient table 73. The toner consumption calculating portion 80 calculates the toner consumption of the output image, based on the sum value of the pixel count calculated by the pixel counting portion 70 (summed by the summing means 74).

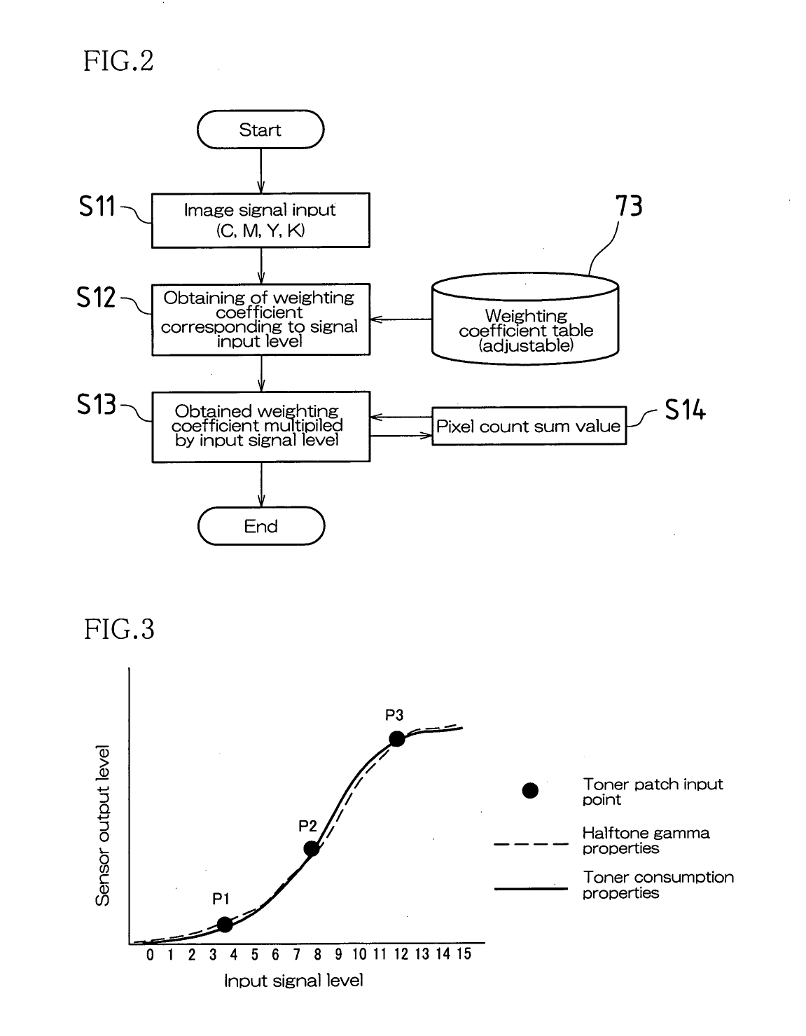

The toner consumption calculation for a single pixel is explained using FIG. 2. As shown in FIG. 2, when the signal for a single pixel that is part of the multi-level image is input into the pixel counting portion 70 (Step S11), the input signal level is counted by the counting means 71. Next, a weighting coefficient corresponding to the input signal level is obtained by the weighting calculation means 72 from the weighting coefficient table 73 (Step S12), and the obtained weighting coefficient is multiplied by the input signal level (Step S13). Based on the pixel count for a single pixel calculated in this way, the toner consumption for that single pixel is calculated by the toner consumption calculating portion 80. In step S13, the pixel count values calculated for each single pixel are sequentially summed by the summing means 74, and saved as a pixel count sum value (Step S14). The pixel count sum value is a pixel count value for all of the input pixels, and based on this pixel count sum value, the toner consumption of the output image is calculated by the toner consumption calculating portion 80.

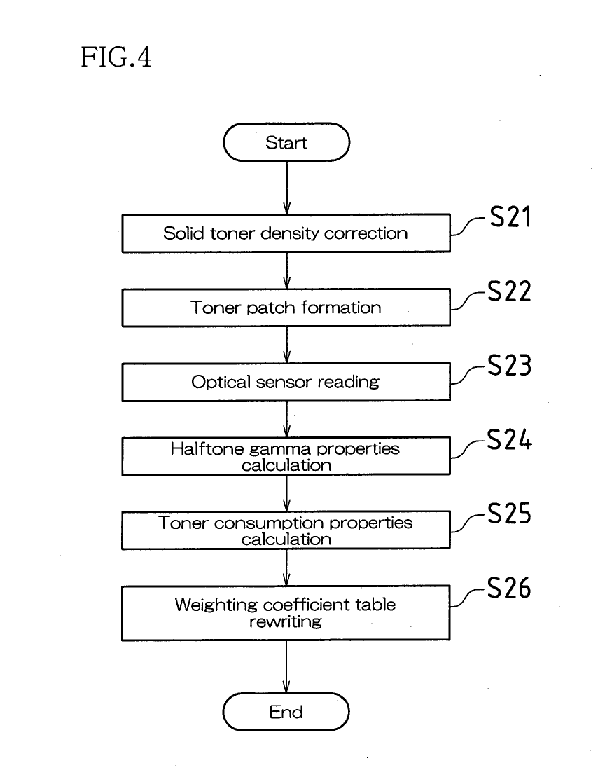

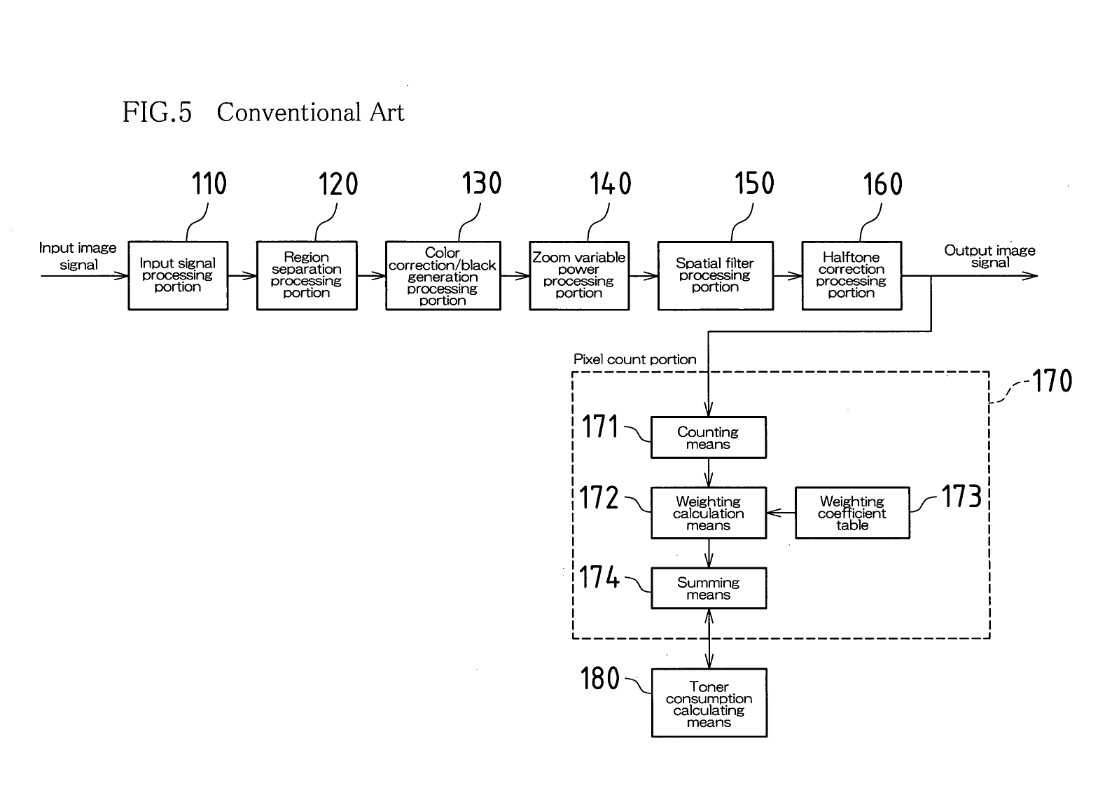

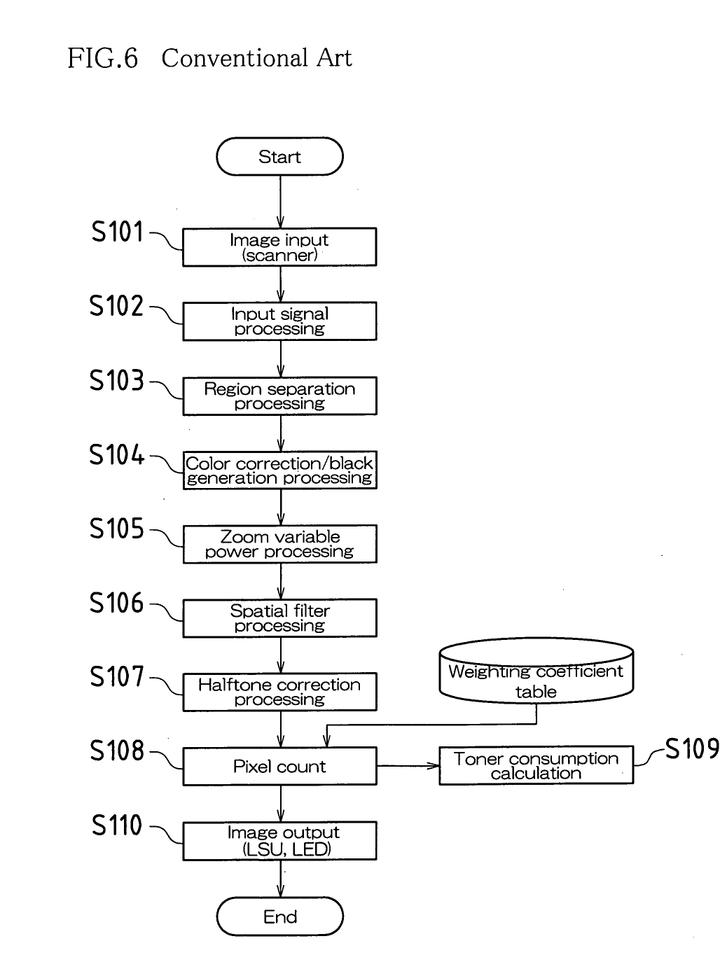

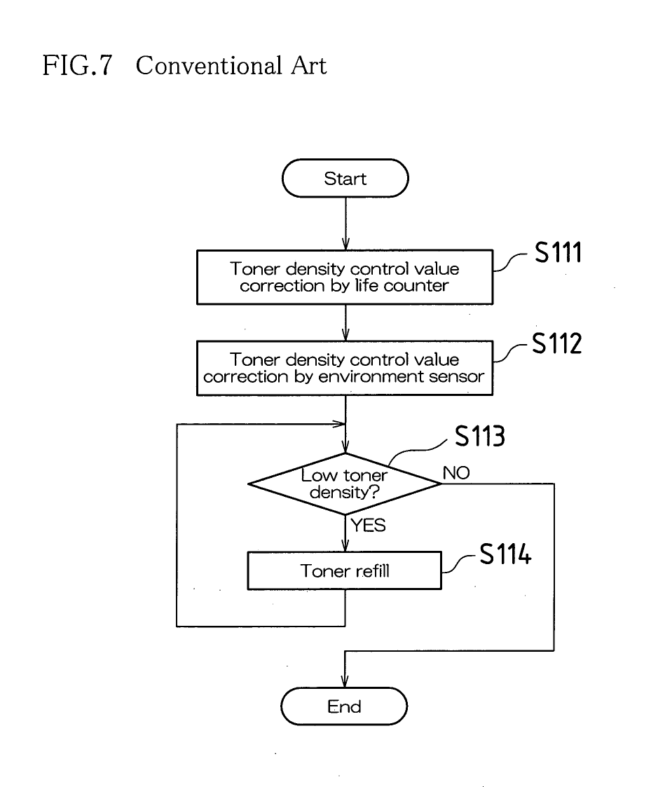

The rewriting of the weighting coefficient table 73 is explained using FIG. 3 and FIG. 4. The weighting coefficients stored in the weighting coefficient table 73 are adjustable, unlike in the conventional technology, and can be rewritten by the rewriting means 75. One example of the weighting coefficient table 73, for the case of a 16-level input signal level that takes on input signal levels 0 to 15, is shown in the following Table 2.

TABLE 2
Weighting Coefficient Table (Adjustable)

| Signal | Weighting |
|---|---|
| input level | coefficient |
| 0 | X0 |
| 1 | X1 |
| 2 | X2 |
| 3 | X3 |
| 4 | X4 |
| 5 | X5 |
| 6 | X6 |
| 7 | X7 |
| 8 | X8 |
| 9 | X9 |
| 10 | X10 |
| 11 | X11 |
| 12 | X12 |
| 13 | X13 |
| 14 | X14 |
| 15 | X15 |

In Table 2, the weighting coefficients (X0 to X15) corresponding to the input signal levels 0 to 15 are each adjustable. The weighting coefficients X0 to X15 are rewritten as follows by the rewriting means 75.

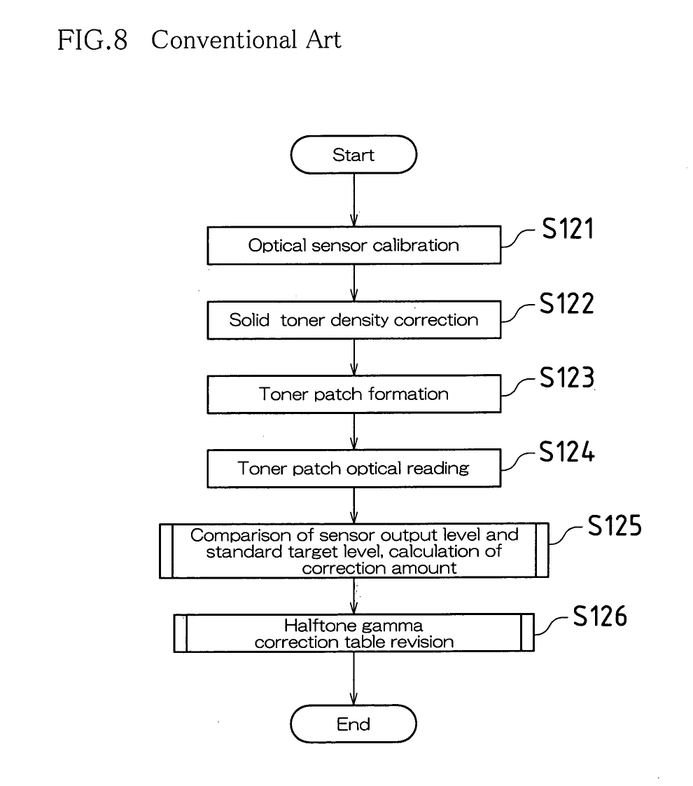

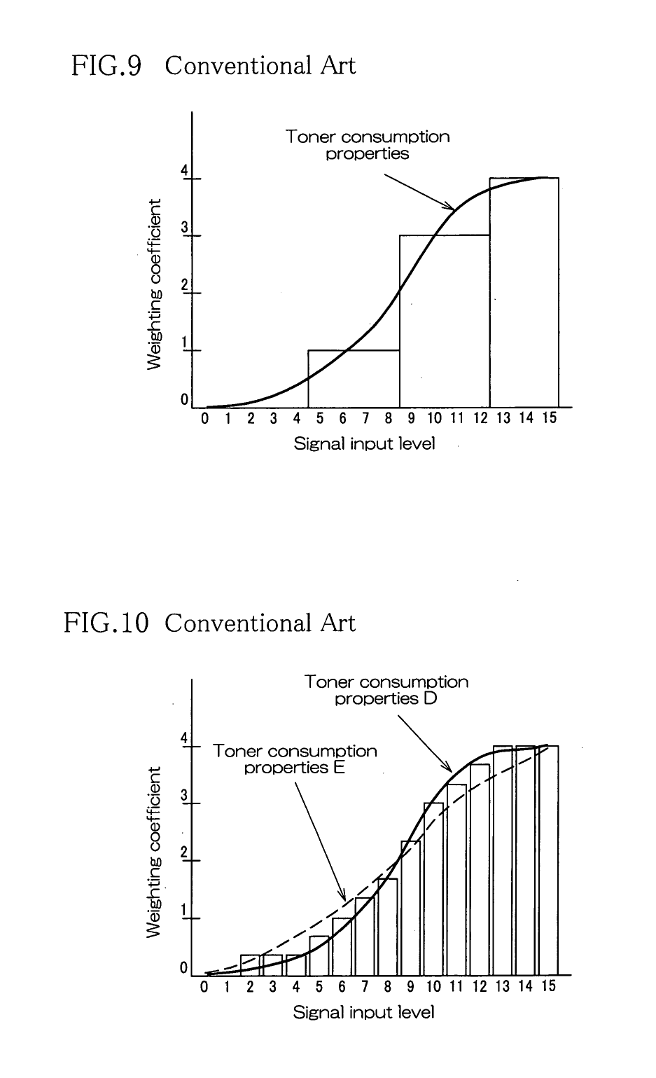

First, after the toner density has been corrected (Step S21), a plurality of toner patches having mutually differing tones, as shown by points P1 to P3 in FIG. 3, are formed of the photosensitive body or transfer belt (Step S22). That is, halftone toner patches for a plurality of input points set in advance are formed on the photosensitive body or transfer belt. Then, the amount of reflected light of those toner patches is read by a reading means 90 (see FIG. 1) such as an optical sensor (Step S23). In FIG. 3, the vertical axis is the sensor output of the reading means 90 such as an optical sensor, and the horizontal axis is the signal output level (grade). There is no particular limitation to the number of input points, but it is preferable to have at least three points. The procedure of the above steps S21 to S23 is similar to the steps S122 to S124 in the halftone gamma correction process shown in FIG. 8, stated above in the section explaining the conventional technology, and so the following procedure may also be performed, using the results of this halftone gamma correction process.

Next, based on the sensor output of toner patches for a plurality of input points, the halftone gamma properties as shown by the broken line in FIG. 3 are calculated (Step S24). Based on the calculated halftone gamma properties, the toner consumption properties for the signal input levels as shown by the solid line in FIG. 3 are calculated (Step S25). Based on the toner consumption properties calculated in this manner, the weighting coefficients are determined, and the weighting coefficients stored in the weighting coefficient table 73 are rewritten to the determined weighting (Step S26). In the case of Table 2, the weighting coefficients X0 to X15 corresponding to the input signal levels 0 to 15 are rewritten according to the toner consumption properties.

In this way, a pixel count of the input multi-level image is performed by the pixel counting portion 70 using the weighting coefficient rewritten by the rewriting means 75, and the toner consumption of the output image is calculated by the toner consumption calculating portion 80.

In this way, even when actual toner consumption properties have changed due to individual differences and toner life, it is possible to follow the changes in toner consumption properties and rewrite the weighting coefficient table 73, and the calculation of toner consumption properties can be optimized. The result of this is that toner properties can be accurately calculated irrespective of individual differences or toner life. That is, it is possible to hold the discrepancy between the actual toner consumption and the toner consumption calculated using the weighting coefficient table 73 rewritten by the rewriting means 75 to a low level.

The present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

What is claimed is:

1. An image forming apparatus that digitally performs image processing and correction processing of image information, and calculates toner consumption by performing a pixel count of an input multi-level image, the image forming apparatus comprising:
a counting portion that counts, pixel by pixel, input signal levels of the input multi-level image;
a weighting coefficient table that stores weighting coefficients corresponding to the input signal levels; and
a weighting calculation portion that obtains from the weighting coefficient table weighting coefficients corresponding to the input signal levels and performs weighting of each pixel when counting the input signal levels with the counting portion;
wherein the weighting coefficients stored in the weighting coefficient table are adjustable.

2. An image forming apparatus that digitally performs image processing and correction processing of image information, and calculates toner consumption by performing a pixel count of an input multi-level image, the image forming apparatus comprising:
a counting portion that counts, pixel by pixel, input signal levels of the input multi-level image;
a weighting coefficient table that stores weighting coefficients corresponding to the input signal levels;
a weighting calculation portion that obtains from the weighting coefficient table weighting coefficients corresponding to the input signal levels and performs weighting of each pixel when counting the input signal levels with the counting portion; and
a rewriting portion that rewrites the weighting coefficients stored in the weighting coefficient table.

3. The image forming apparatus according to claim 2,
further comprising a reading portion that reads a toner patch,
wherein the rewriting portion forms a plurality of toner patches having mutually differing tones on a photosensitive body or transfer belt, reads these toner patches with the reading portion, calculates halftone gamma properties based on the result of reading these toner patches, and rewrites the weighting coefficients stored in the weighting coefficient table according to these calculated halftone gamma properties.
